(19) United States
(12) Patent Application Publication
(10) Pub. No.: US 2012/0123053 A1
(43) Pub. Date: May 17, 2012

(54) CARBON FIBER

(76) Inventors: Makoto Kibayashi, Decatur, AL (US); Satoshi Seike, Decatur, AL (US); Lawrence A. Pranger, Decatur, AL (US); Anand Valliyur Rau, Decatur, AL (US)

(21) Appl. No.: 12/947,160

(22) Filed: Nov. 16, 2010

(51) Int. Cl. C08K 3/04; D02G 3/02

(52) U.S. Cl. 524/606; 428/367

(57) ABSTRACT

A carbon fiber is coated with a sizing at an amount X between 0.1 and 0.3 wt %. The sizing is formed of a heat resistant polymer or a precursor of the heat resistant polymer. The amount X of the sizing is expressed with a following formula:

$$X = \frac{{w}_{0} - {w}_{1}}{{w}_{0}} \times 100$$

where W₀ is a weight of the carbon fiber with the sizing, and W₁ is a weight of the carbon fiber without the sizing.

### BACKGROUND OF THE INVENTION AND RELATED ART STATEMENT

The present invention relates to a carbon fiber with a sizing capable of achieving superior resistance against thermal degradation.

Carbon fiber reinforced plastics (CFRP) have superior mechanical properties such as high specific strength and high specific modulus; therefore, they are widely used for a wide variety of applications, e.g., aerospace, sports equipment, industrial good, and the like. In particular, CFRP with a matrix consisting of a thermoplastic resin has a great advantage such as quick molding characteristics and superior impact strength. In recent years, research and development efforts in this area have been flourishing.

In general, polymer type composite materials tend to reduce strength and modulus under high temperature conditions. Thereby, heat resistant matrix resins are necessary in order to maintain desired mechanical properties under high temperature conditions. Such heat resistant matrix resins include a thermosetting polyimide resin, a urea formaldehyde resin, a thermoplastic polyimide resin, a polyamideimide resin, a polyetherimide resin, a polysulfone resin, a polyethersulfone resin, a polyetheretherketone resin, a polyetherketoneketone resin, and a polyphenylenesulfide resin.

CFRP with heat resistant matrix resins are molded under high temperature conditions, so a sizing must withstand thermal degradation. If the sizing experiences thermal degradation, voids and some other problems occur inside a composite, resulting in undesired composite mechanical properties. Accordingly, a heat resistant sizing is an essential part of CFRP for better handleability, superior interfacial adhesive capability, controlling fuzz development, etc.

A conventional heat resistant sizing has been developed and tried in the past. For instance, U.S. Pat. No. 4,394,467 and U.S. Pat. No. 5,401,779 have disclosed a polyamic acid oligomer as an intermediate agent generated from a reaction of an aromatic diamine, an aromatic dianhydride, and an aromatic tetracarboxylic acid diester. When the intermediate agent is applied to a carbon fiber in an amount of 0.3-5 wt % (or more desirably 0.5-1.3 wt %), it is possible to produce a polyimide coating. However, the sizing amount of 0.5-1.3 wt % does not seem efficient in terms of drape ability and spreadability for resin impregnation. The composite mechanical properties tend to be lower than a desirable level.

In U.S. Pat. No. 5,155,206 and U.S. Pat. No. 5,239,046, a composition of the polyamideimide as the sizing has been disclosed. However, the sizing amount that is essential to obtain the optimal mechanical properties has not been disclosed.

In view of the problems described above, an object of the present invention is to provide a carbon fiber with high mechanical property in addition to superior resistance to thermal degradation and capability for resin impregnation.

Further objects and advantages of the invention will be apparent from the following description of the invention.

### SUMMARY OF THE INVENTION

In order to attain the objects described above, according to the present invention, a carbon fiber is coated with a sizing at an amount X between 0.1 and 0.3 wt %. The sizing is formed of a heat resistant polymer or a precursor of the heat resistant polymer. The amount X of the sizing is expressed with a following formula:

$$X = \frac{{w}_{0} - {w}_{1}}{{w}_{0}} \times 100$$

where W₀ is a weight of the carbon fiber with the sizing, and W₁ is a weight of the carbon fiber without the sizing.

### BRIEF DESCRIPTION OF THE DRAWINGS

FIG. 1 is a graph showing a relationship between strand tensile strength and sizing amount (polyetherimide, T800SC-24K);

FIG. 2 is a graph showing a relationship between drape value and sizing amount (polyetherimide, T800SC-24K)

FIG. 3 is a graph showing a relationship between rubbing fuzz and sizing amount (polyetherimide, T800SC-24K);

FIG. 4 is a graph showing a relationship between ILSS and sizing amount (polyetherimide, T800SC-24K);

FIG. 5 is a graph showing a TGA measurement result (polyetherimide, T800SC-24K);

FIG. 6 is a graph showing a relationship between strand tensile strength and sizing amount (polyimide, T800SC-24K);

FIG. 7 is a graph showing a relationship between drape value and sizing amount (polyimide, T800SC-24K);

FIG. 8 is a graph showing a relationship between rubbing fuzz and sizing amount (polyimide, T800SC-24K);

FIG. 9 is a graph showing a relationship between ILSS and sizing amount (polyimide, T800SC-24K);

FIG. 10 is a graph showing a TGA measurement result (polyimide, T800SC-24K);

FIG. 11 is a graph showing a relationship between strand tensile strength and sizing amount (polyimide, T700SC-12K);

FIG. 12 is a graph showing a relationship between drape value and sizing amount (polyimide, T700SC-12K);

FIG. 13 is a graph showing a relationship between rubbing fuzz and sizing amount (polyimide, T700SC-12K);

FIG. 14 is a graph showing a relationship between ILSS and sizing amount (polyimide, T700SC-12K);

FIG. 15 is a graph showing a relationship between strand tensile strength and sizing amount (PPS, T700SC-12K);

FIG. 16 is a graph showing a relationship between drape value and sizing amount (PPS, T700SC-12K);

FIG. 17 is a graph showing a relationship between rubbing fuzz and sizing amount (PPS, T700SC-12K);

FIG. 18 is a graph showing a relationship between ILSS and sizing amount (PPS, T700SC-12K);

FIG. 19 is a schematic view showing a measurement procedure of drape value;

FIG. 20 is a schematic view showing a measurement instrument of rubbing fuzz;

FIG. 21 is a schematic view showing a chemical structure of polyamic acid precursor for polyetherimide;

FIG. 22 is a schematic view showing a chemical structure of polyetherimide;

FIG. 23 is a schematic view showing a chemical structure of polyamic acid precursor for polyimide;

FIG. 24 is a schematic view showing a chemical structure of polyimide;

Table 1 is a table showing a relationship between strand tensile strength and sizing amount (polyetherimide, T800SC-24K);

Table 2 is a table showing a relationship between drape value and sizing amount (polyetherimide, T800SC-24K);

Table 3 is a table showing a relationship between rubbing fuzz and sizing amount (polyetherimide, T800SC-24K);

Table 4 is a table showing a relationship between ILSS and sizing amount (polyetherimide, T800SC-24K);

Table 5 is a table showing a relationship between strand tensile strength and sizing amount (polyimide, T800SC-24K);

Table 6 is a table showing a relationship between drape value and sizing amount (polyimide, T800SC-24K);

Table 7 is a table showing a relationship between rubbing fuzz and sizing amount (polyimide, T800SC-24K);

Table 8 is a table showing a relationship between ILSS and sizing amount (polyimide, T800SC-24K);

Table 9 is a table showing a relationship between strand tensile strength and sizing amount (polyimide, T700SC-12K);

Table 10 is a table showing a relationship between drape value and sizing amount (polyimide, T700SC-12K);

Table 11 is a table showing a relationship between rubbing fuzz and sizing amount (polyimide, T700SC-12K);

Table 12 is a table showing a relationship between ILSS and sizing amount (polyimide, T700SC-12K);

Table 13 is a table showing a relationship between strand tensile strength and sizing amount (PPS, T700SC-12K);

Table 14 is a table showing a relationship between drape value and sizing amount (PPS, T700SC-12K);

Table 15 is a table showing a relationship between rubbing fuzz and sizing amount (PPS, T700SC-12K);

Table 16 is a table showing a relationship between ILSS and sizing amount (PPS, T700SC-12K); and

Table 17 is a table showing a comparison result of composite properties.

### DETAILED DESCRIPTION OF PREFERRED EMBODIMENTS

Embodiments of the present invention will be explained with reference to the accompanying drawings.

In the embodiment, a commercially available carbon fiber is used (including graphite fiber). Specifically, a pitch type carbon fiber, a rayon type carbon fiber, or a PAN (polyacrylonitrile) type carbon fiber is used. Among these carbon fibers, the PAN type carbon fibers that have high tensile strength are the most desirable for the invention.

Among the carbon fibers, there are a twisted carbon fiber and a never twisted carbon fiber. The carbon fibers have preferably a yield of 0.06-4.0 g/m and a filament number of 1,000 to 48,000. In order to have high tensile strength and high tensile modulus in addition to preventing single filament breakage from happening during the carbon fiber production, the single filament diameter should be within 3 μm to 8 μm, more ideally, 4 μm to 7 μm.

Strand strength is 4.5 GPa or above. 5.0 GPa or above is more desirable. 5.5 GPa or above is even more desirable. Tensile modulus is 200 GPa or above. 220 GPa or above is more desirable. 240 GPa or above is even more desirable. If the strand strength and modulus of the carbon fiber are below 4.5 GPa and 200 GPa, respectively, it is difficult to obtain the desirable mechanical property values when the carbon fiber is made into composites materials.

In order to apply a sizing to the carbon fibers, a continuous application is preferred. In order to obtain high level of properties, it is desirable to use continuous fiber when molding, and chopped and/or long fiber reinforced thermoplastic pellet may also be used. In terms of the types of carbon fibers, chopped fiber for mold injection, continuous fiber for filament winding or pultrusion, or weaving, brading, or a mat form could be also used.

In order for the carbon fiber to have superior spreadability and effective resin impregnation, a drape value (measured by the procedures described below) should be less than 15 cm, 12 cm or less is better, 10 cm or less is even more desirable, 8 cm or less is most desirable.

As to the matrix resin, either thermosetting or thermoplastic resins could be used. As for the thermosetting resins, the invention is not limited to any particular resins, and a thermosetting polyimide resin, an epoxy resin, a polyester resin, a polyurethane resin, a urea resin, a phenol resin, a melamine resin, a cyanate ester resin, and a bismaleimide resin may be used. As for the thermoplastic resin, resins, mostly heat resistant resins, that contain oligomer could be used. The invention is not limited to any particular heat resistant thermoplastic resins, and a thermoplastic polyimide resin, a polyamideimide resin, a polyetherimide resin, a polysulfone resin, a polyethersulfone resin, a polyetheretherketone resin, a polyetherketoneketone resin, and a polyphenylenesulfide resin may be used.

A heat resistant polymer is a desirable sizing agent to be used for coating the carbon fiber. The sizing agents include a phenol resin, a urea resin, a melamine resin, a polysulfone resin, a polyethersulfone resin, a polyetheretherketone resin, a polyetherketoneketone resin, a polyphenylenesulfide resin, a polyimide resin, a polyamideimide resin, a polyetherimide resin, and others.

Generally, a polyimide is made by heat reaction or chemical reaction of polyamic acid. During the imidization process, water is generated as a condensation product; therefore, it is important to complete imidization before composite fabrication. Otherwise, voids could become a problem due to water generation. A water generation ratio W at the imidization process can be defined by the following equation:

W(%)=B/A×100

where a weight A is measured after holding 2 hours at 110 degree Celsius and a weight difference B is measured between 130 degree Celsius and at 415 degree Celsius under air atmosphere with TGA (holding 110 degree Celsius for 2 hours, then heating up to 450 degree Celsius at 10 degree Celsius/min).

The water generation ratio W of 0.05% or less is acceptable, and 0.03% or less is desirable. Ideally, 0.01% or less is optimal. An imidization ratio X of 80% or better is acceptable, and 90% or better is desirable. Ideally, 95% or better is optimal. The imidization ratio X is defined by the following equation:

X(%)=(1−D/C)×100

where a weight loss ratio C of a polyamic acid without being imidized and a weight loss ratio D of a polyimide are measured between 130 degree Celsius and 415 degree Celsius under air atmosphere with TGA (holding 110 degree Celsius for 2 hours, then heating up to 450 degree Celsius at 10 degree Celsius/min).

A degree of imidization is qualitatively measured using an infrared absorption spectrum of the polyimide with FTIR (Fourier transform infrared spectroscopy) which enables to measure the spectrum absorption level of an imide bond (C═O stretching vibration) at approximately 1,780 cm⁻¹.

A weight loss ratio Ws based on the sizing amount can be defined by the following equation:

Ws(%)=E/F×100

where a weight F is the amount of the sizing and a weight difference E is measured between 130 degree Celsius and at 415 degree Celsius under air atmosphere with TGA (holding 110 degree Celsius for 2 hours, then heating up to 450 degree Celsius at 10 degree Celsius/min).

The weight loss ratio based on the sizing amount of 7% or less is acceptable, and 5% or less is desirable. Ideally, 3% or less is optimal.

The heat resistant polymer is preferably used in a formed of an organic solvent solution, a water solution, a water dispersion or a water emulsion of the polymer itself or a polymer precursor. A polyamic acid which is the precursor to a polyimide is enabled to be water soluble by neutralization with alkali. It is better for alkali to be water soluble. Chemicals such as ammonia, a monoalkyl amine, a dialkyl amine, a trialkyl amine, and tetraalkylammonium hydroxide could be used.

Organic solvents such as DMF (dimethylformamide), DMAc (dimethylacetamide), DMSO (dimethylsulfoxide), NMP (N-methylpyrrolidone), THF (tetrahydrofuran), etc. could be used. Naturally, low boiling point and safe solvents should be selected. It is desirable that the sizing agent is dried and sometimes reacted chemically in low oxygen concentration air or inert atmosphere such as nitrogen to avoid forming explosive mixed gas. After the heat resistant polymer or polymer precursor is applied to the carbon fiber, it is dried and sometimes reacted chemically in order to obtain heat resistant polymer coating.

### <Glass Transition Temperature>

The sizing has a glass transition temperature above 100 degree Celsius. Above 150 degree Celsius is better. Even more preferably the glass transition temperature shall be above 200 degree Celcius.

A glass transition temperature is measured according to ASTM E1640 using a Differential Scanning calorimetry (DSC).

### <Thermal Degradation Onset Temperature>

A sizing degradation temperature is preferably above 450 degree Celsius. 500 degree Celsius or higher is more desirable, 550 degree Celsius or higher is most desirable. When a thermal degradation onset temperature is measured, first, a sample with a weight of about 5 mg is placed on a thermogravimetric analyzer (TGA) under air atmosphere. Then, the sample is analyzed under an air flow of 50 ml/minute at a heating ratio of 10 degree Celsius/minute. A weight change is measured between room temperature and 600 degree Celsius. The degradation onset temperature of the sizing is defined as a temperature at which an onset of a major weight loss occurs. From the TGA experimental data, the sample weight, expressed as a percentage of the initial weight, is plotted as a function of the temperature (abscissa). By drawing tangents on a curve, the degradation onset temperature is defined as an intersection point where tangent at a steepest weight loss crosses a tangent at minimum gradient weight loss adjacent to the steepest weight loss on a lower temperature side. When the sizing amount is too low and it is difficult to measure the carbon fiber with the sizing, only the sizing may be measured.

### <Sizing Agent Application Method>

A sizing agent application method includes a roller sizing method, a submerged roller sizing method and/or a spray sizing method. The submerged roller sizing method is desirable because it is possible to apply a sizing agent very evenly even to large filament count tow fibers. Sufficiently spread carbon fibers are submerged in the sizing agent. In this process, a number of factors become important such as a sizing agent concentration, temperature, fiber tension, etc. for the carbon fiber to attain the optimal sizing amount for the ultimate objective to be realized. Often, ultrasonic agitation is applied to vibrate carbon fiber during the sizing process for better end results.

In order to achieve a sizing amount 0.1 to 0.3 wt % on the carbon fiber, a concentration of the sizing agent is preferably 0.1 to 2.0 wt %, more preferably 0.2 to 1.0 wt %. If the sizing amount is less than 0.1 wt %, when carbon fiber tow is spread with some tension, fuzz becomes an issue. If on the other hand, the sizing amount is above 0.3 wt %, the carbon fiber is completely coated by the heat resistant polymer and would develop voids, resulting in poor density (low), and poor spreadability. When this occurs, even low viscosity resins such as epoxy have experienced reduced impregnation; thereby leading to low mechanical properties.

### <Drying Treatment>

After the sizing application process, the carbon fiber goes through the drying treatment process in which water and/or organic solvent will be dried, which are solvent or dispersion media. Normally an air dryer is used and the dryer is run for six seconds to fifteen minutes. The dry temperature should be set at 250 degree Celsius to 450 degree Celsius, 260 degree Celsius to 400 degree Celsius would be more ideal, 270 degree Celsius to 350 degree Celsius would be even more ideal-280 degree Celsius to 330 degree Celsius would be most desirable.

In case of thermoplastic dispersion, it is desirable that it should be dried at over the formed or softened temperature. This could also serve a purpose of reacting to the desired polymer characteristics. For this invention, the heat treatment will possibly be used with a higher temperature than the temperature used for the drying treatment. The atmosphere to be used for the drying treatment should be air; however, when an organic solvent is used in the process, an inert atmosphere involving elements such as nitrogen could be used.

### <Winding Process>

The carbon fiber tow, then, is wound onto a bobbin. The carbon fiber produced as described above is evenly sized. This helps make desired carbon fiber reinforced composites materials when mixed with the resin.

### EXAMPLES

Examples of the carbon fiber will be explained next. Following methods are used for evaluating properties the carbon fiber.

### <Sizing Amount>

The sizing amount (wt %) was measured by the following method. Take about 5 g of the carbon fiber, and the specimen was put in the dryer for 1 hour with 110 degree Celsius. Following, it was put in the desiccators to be cooled off at the ambient temperature (room temperature). Then, a weight W₀ was weighed. For removing the sizing by alkaline degradation, the carbon fiber was put in 5% KOH solution at 80° C. for 4 hours. Next the de-sized specimen was rinsed with enough water and put in the dryer for 1 hour with 110 degree Celsius. Following, it was put in the desiccators to be cooled off at the ambient temperature (room temperature). Then, a weight W₁ was weighed. The sizing amount (wt %) was calculated by the following formula.

Sizing amount (weight %)=(W₀−W₁)/(W₀)×100

### <Strand Mechanical Properties>

Tensile strength and tensile modulus of the strand specimen made of polymer coated carbon fiber and epoxy resin matrix was measured by ASTM D4018.

### <Drape Value>

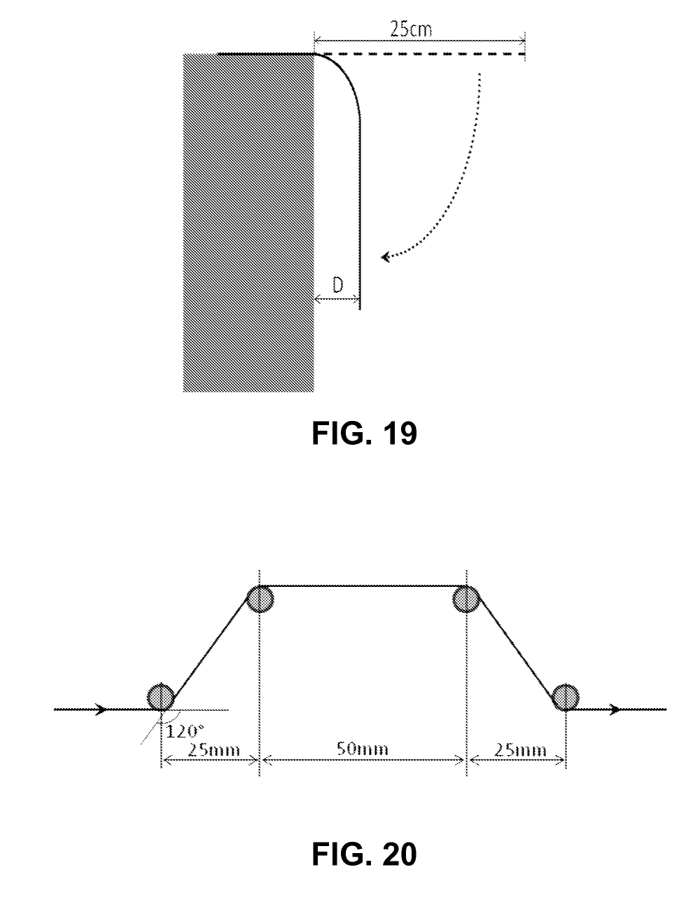

The carbon fiber tow was cut about 50 cm long from the bobbin without applying any tension. One end of the specimen was glued on the desk, and a weight was placed on the other end of the specimen. After a twist and/or bend of the specimen were removed, the specimen was placed for 30 minutes. The weight was 30 g for 12,000 filaments and 60 g for 24,000 filaments, so that 1 g tension was applied per 400 filaments. After the weight was released from the specimen, as shown in FIG. 19, the specimen was placed on a rectangular table such that a portion of the specimen was extended by 25 cm from an edge of the table having 90 degree angle. The specimen on the table was fixed with an adhesive tape without breaking, so that the portion hung down from the edge of the table. A distance between a tip of the specimen and a side of the table was the drape value.

### <Fuzz Count>

As shown in FIG. 20, the carbon fiber tow was slid against four pins with a diameter of 10 mm (material: chromium steel, surface roughness: 1-1.5 μm RMS) at a speed of 3 meter per minute in order to generate fuzz. The carbon fiber initial tension is 500 g for the 12,000 filament strand and 650 g for 24,000 filament strand. The carbon fiber was slid against the pins by an angle of 120 degrees. The four pins are placed (horizontal distance) 25 mm, 50 mm and 25 mm apart (refer to FIG. 20). After the carbon fiber passed through the pins, a fuzz blocked light incident on a photo electric tube from above, so that a fuzz counter counted the fuzz count.

### <Interlaminar Shear Strength (ILSS)>

ILSS of the composites consisting of the polymer coated carbon fiber and an epoxy resin matrix was measured by ASTM D2344.

### Example 1, Comparative Example 1

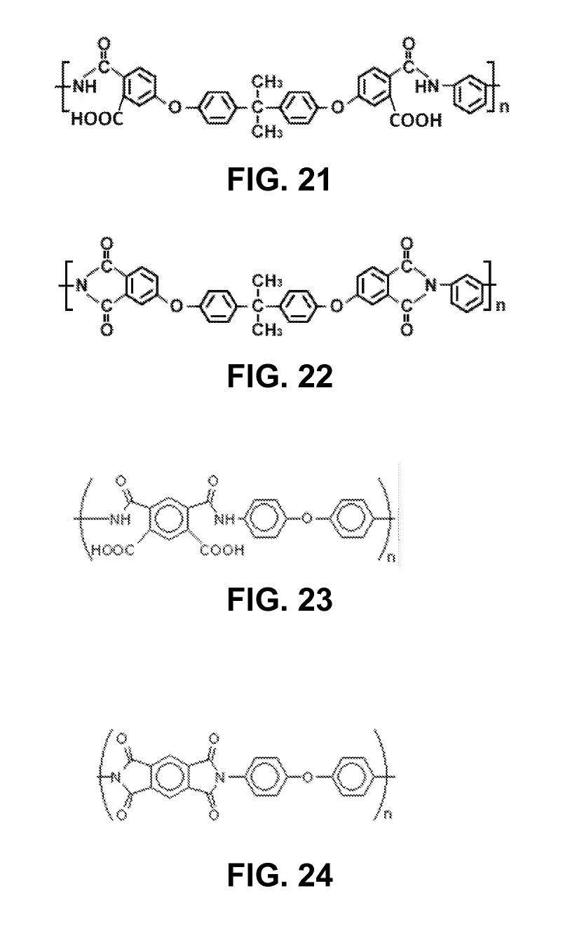

Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing 0.1-2.0 weight % of polyamic acid (indicated in FIG. 21) dimethylaminoethanol salt water solution. After this process, it was dried at 300 degree Celsius for one minute in order to have polyetherimide coating indicated in FIG. 22.

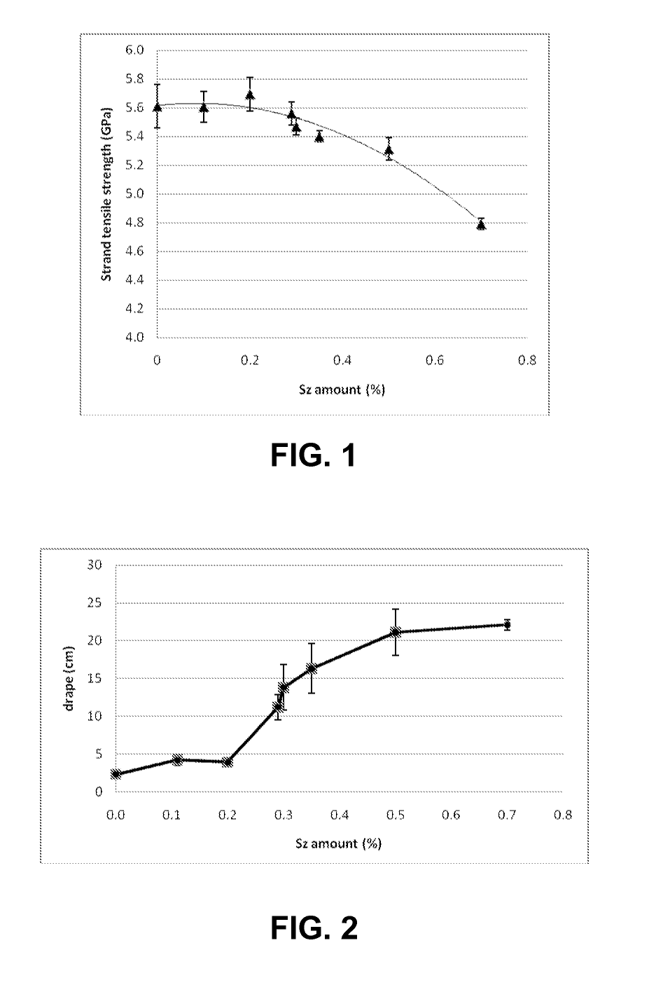

The tensile strengths of both the sizing amount of 0.1-0.3 wt % (Example 1) and 0.3-0.7 wt % (Comparative Example 1) were measured. The results are shown in both Table 1 and FIG. 1. The error bar in the figure indicates the standard deviation. The test sample of Example 1 had a higher tensile strength than the one of Comparative Example 1.

This is in addition to worsened properties due to the ineffectual resin impregnation in the specimen, the intrinsic density has become low as the permeability of the density liquid in the fiber bundle when measured for the comparative example was lower than that of the example 1. Additionally mechanical properties of unsized fiber were also shown. The imidization ratio was 98%.

### Example 2, Comparative Example 2

The same as the above Example 1 and Comparative Example 1, the samples were made, i.e. one with sizing amount of 0.1-0.3 wt % (Example 2) and the other with 0.3-0.7 wt % (Comparative Example 2) to test the drape value. The result is indicated in both Table 2 and FIG. 2. The error bar in the figure indicates the standard deviation. As the sample of Example 2 has superior drapeability than the one of Comparative Example 2, the sample of Example 2 demonstrates the superior spreadability and impregnation. Additionally drape value of unsized fiber were also shown.

### Example 3, Comparative Example 3

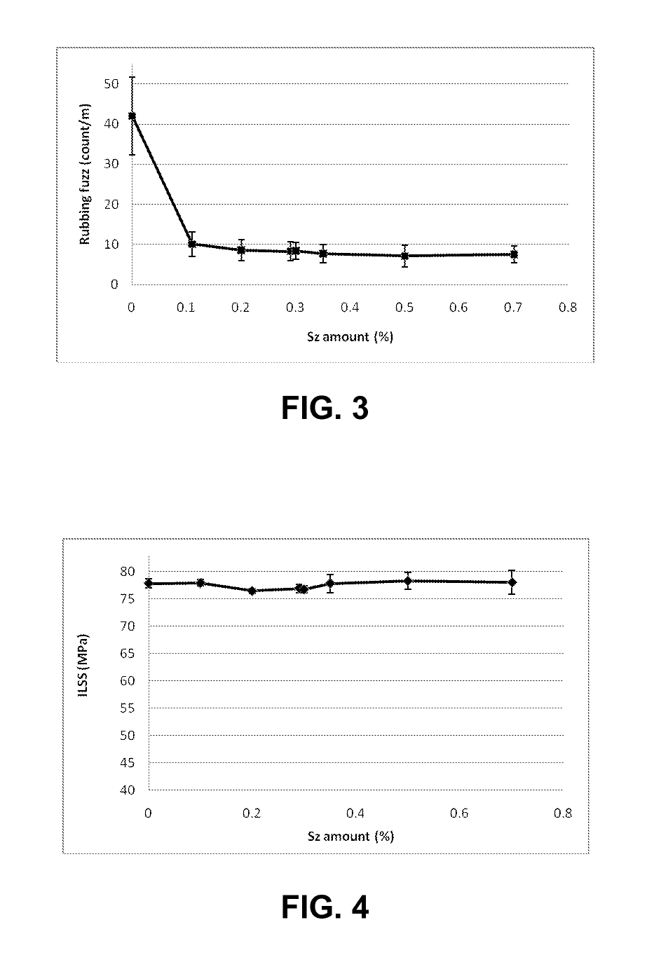

The same as the above Example 1 and Comparative Example 1, the samples were made, i.e. one with sizing amount of 0.1-0.3 wt % (Example 3), the other with 0.3-0.7 wt % (Comparative Example 3) and unsized fiber (Comparative Example 3) to conduct a fuzz count test. The result is shown in Table 3 and FIG. 3. The error bar in the figure indicates the standard deviation. The fuzz count of unsized fiber is extremely high and the fiber with 0.1-0.3 wt % amount sizing showed almost equal fuzz count as the fiber with 0.3-0.7 wt % amount sizing, indicating that the low sizing amount (0.1-0.3 wt %) carbon fiber could be processed as easily.

### Example 4, Comparative Example 4

The same as the above Example 1 and Comparative Example 1, the samples were made, i.e. one with sizing amount of 0.1-0.3 wt % (Example 4) and the other with 0.3-0.7 wt % (Comparative Example 4) to conduct an ILSS test. The result is indicated in both Table 4 and FIG. 4. The error bar in the figure indicates the standard deviation. The ILSS measurements of the both samples taken from the test are almost identical, verifying that the low sized (0.1-0.3 wt %) carbon fiber also has superb interfacial adhesion. Additionally ILSS of unsized fiber were also shown.

### Example 5

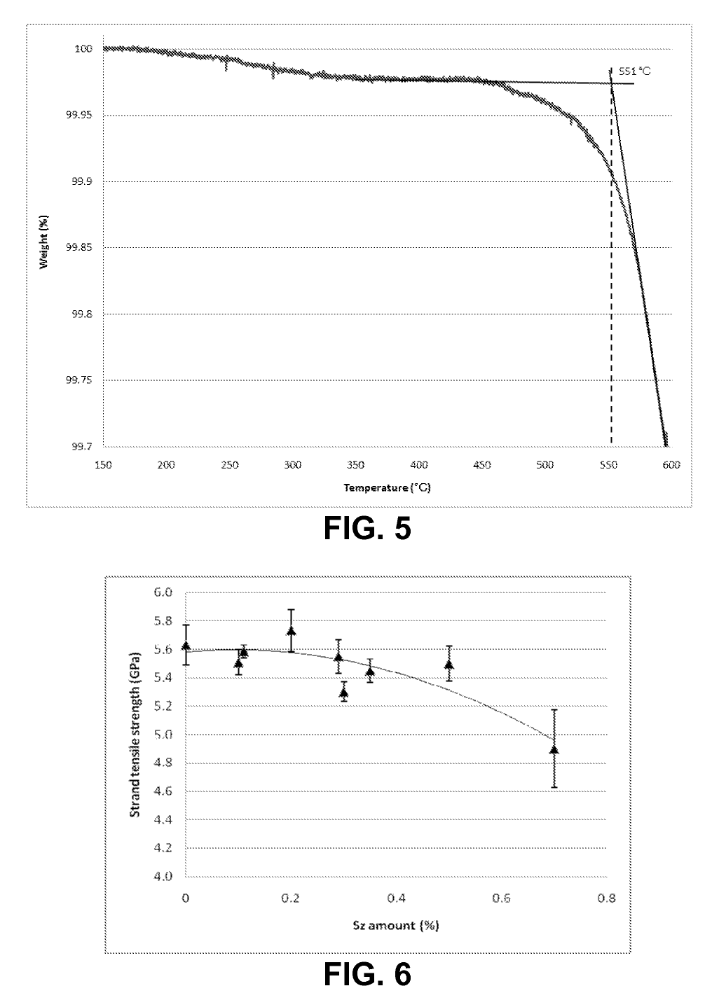

The same as the above Example 1, the carbon fiber with 0.2 wt % sizing amount were made to conduct a thermogravimetric analysis (TGA) under air atmosphere. The result is shown in FIG. 5. The heat degradation onset temperature was 551 degree Celsius, confirming a superior heat resistance demonstrated by the polyetherimide sizing.

### Example 6, Comparative Example 6

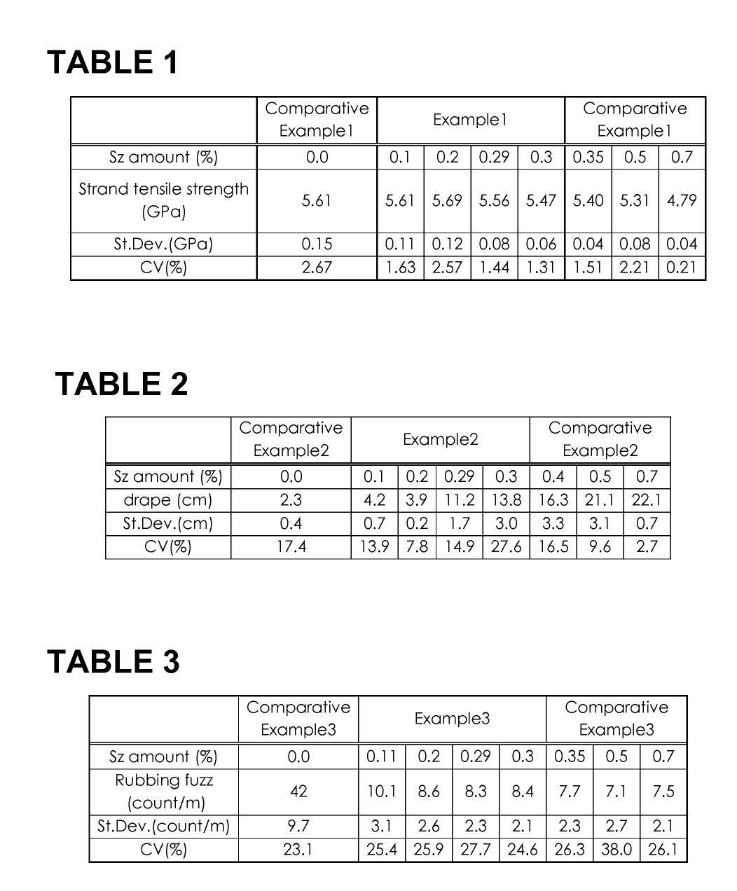

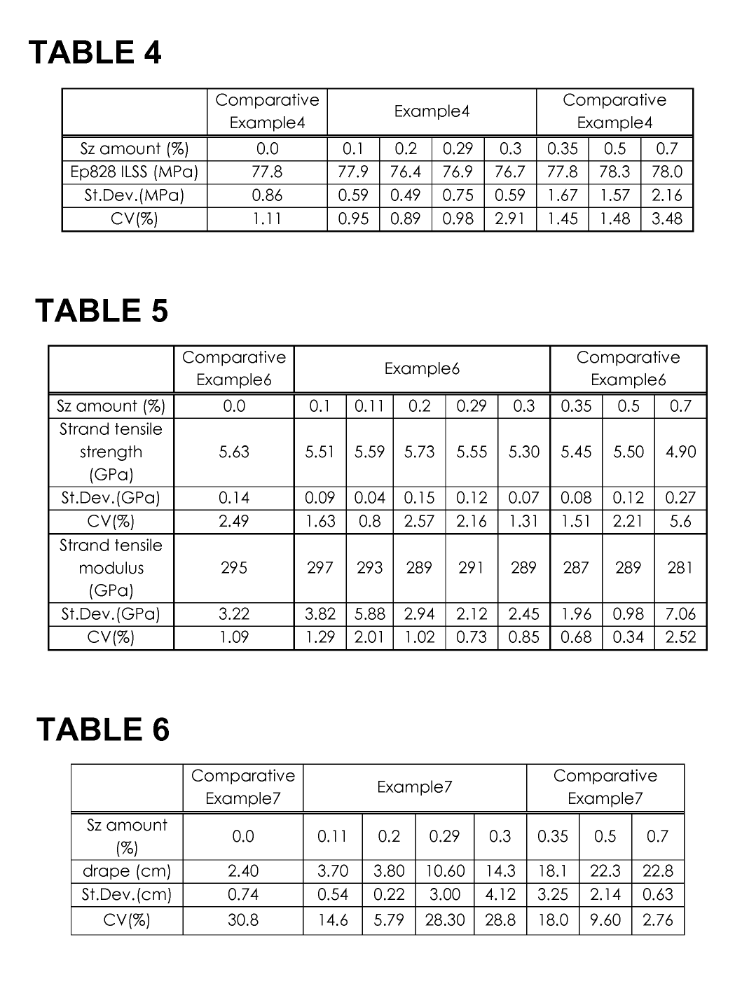

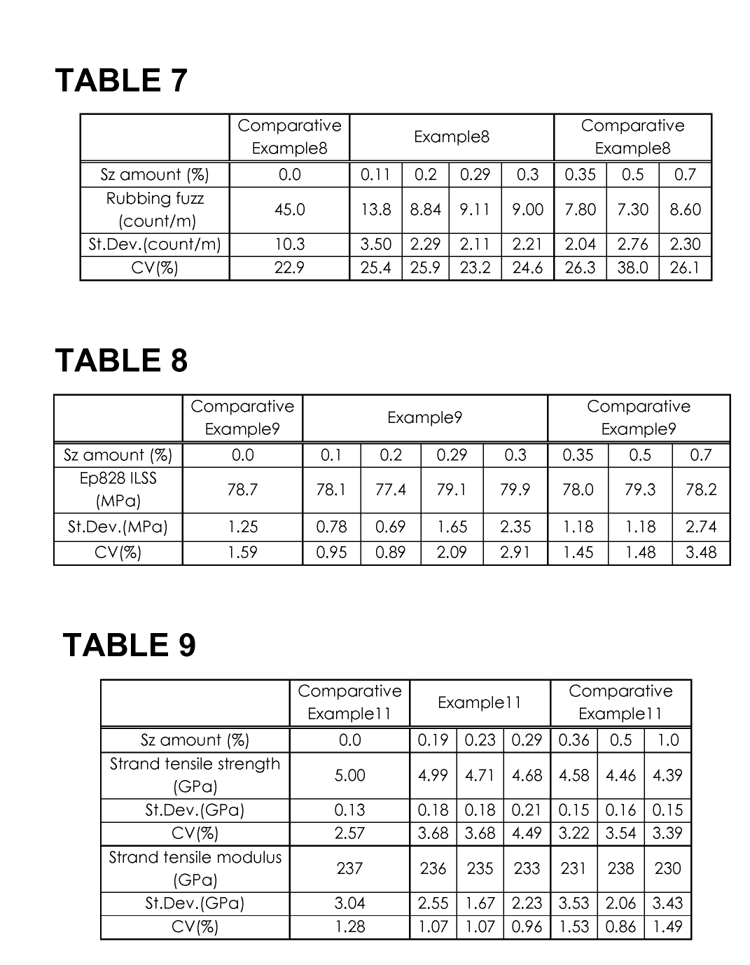

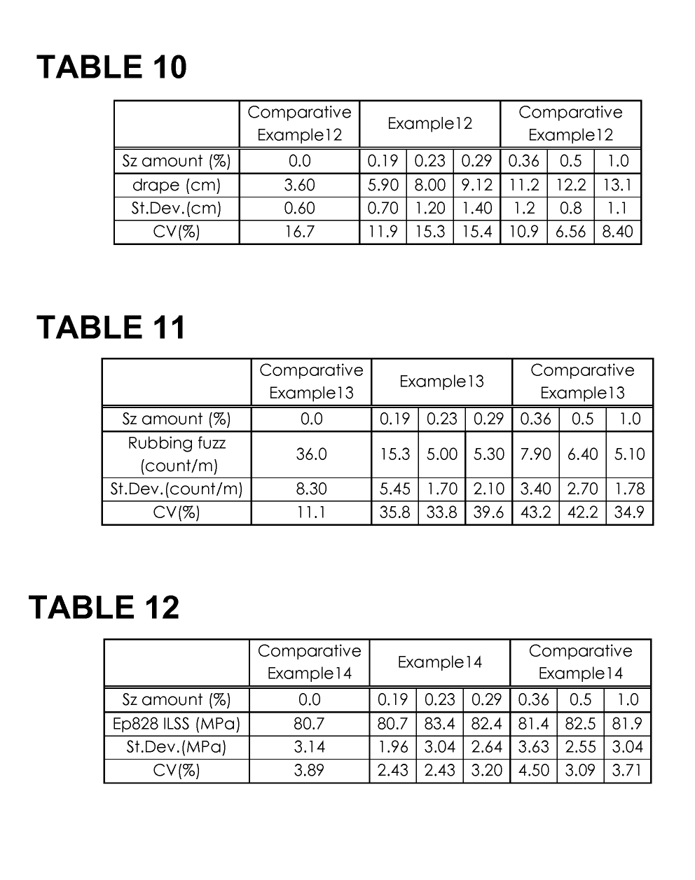

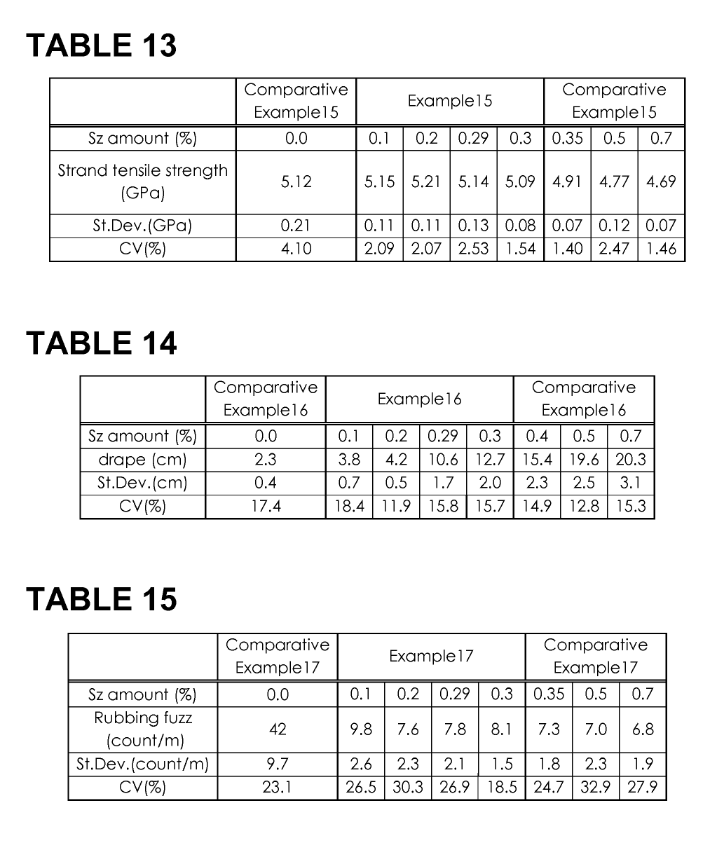

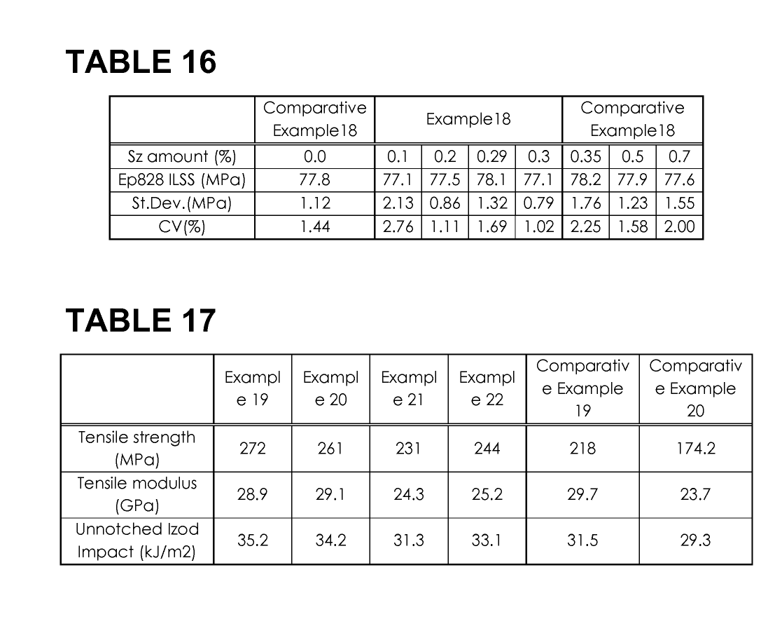

Unsized 24K high tensile strength, intermediate modulus carbon fiber “Torayca” T800SC (Registered trademark by Toray Industries—strand strength 5.9 GPa, strand modulus 294 GPa) was used. The carbon fiber was continuously submerged in the sizing bath containing 0.1-2.0 weight % of polyamic acid DMF solution of which structure is indicated in FIG. 23. After this process, it was dried in nitrogen atmosphere at 290 degree Celsius for one minute in order to have polyimide coating indicated in FIG. 24.

The tensile strengths of both the sizing amount of 0.1-0.3 wt % (Example 6) and 0.3-0.7 wt % (Comparative Example 6) were measured. The results are shown in both Table 5 and FIG. 6. The error bar in the figure indicates the standard deviation. The test sample of Example 6 had a higher tensile strength than the one of Comparative Example 6. Additionally mechanical properties of unsized fiber were also shown. The imidization ratio was 96%.

### Example 7, Comparative Example 7

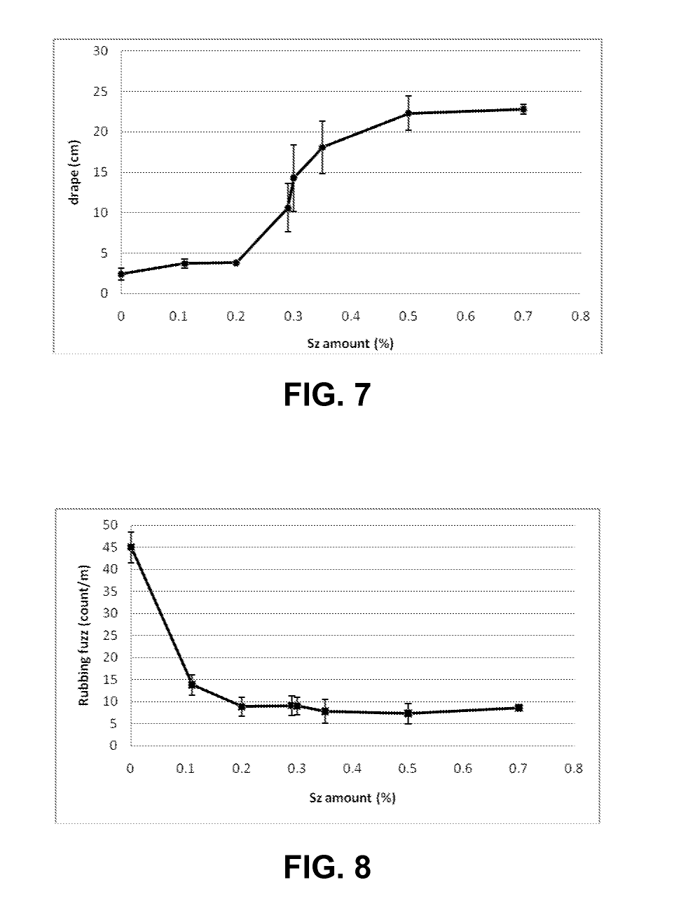

The same as the above Example 6 and Comparative Example 6, the samples were made, i.e. one with sizing amount of 0.1-0.3 wt % (Example 7) and the other with 0.3-0.7 wt % (Comparative Example 7) to test the drape value. The result is indicated in both Table 6 and FIG. 7. The error bar in the figure indicates the standard deviation. The sample of Example 7 has superior drapeability than the one of Comparative Example 7. Additionally drape value of unsized fiber were also shown.

### Example 8, Comparative Example 8

The same as the above Example 6 and Comparative Example 6, the samples were made, i.e. one with sizing amount of 0.1-0.3 wt % (Example 8) and the other with 0.3-0.7 wt % (Comparative Example 8) to conduct a fuzz count test. The result is shown in Table 7 and FIG. 8. The error bar in the figure indicates the standard deviation. The fuzz count of the both samples is almost equal. The carbon fiber without a sizing agent generated much fuzz indicating the effectiveness of sizing in preventing fuzz occurrence.

### Example 9, Comparative Example 9

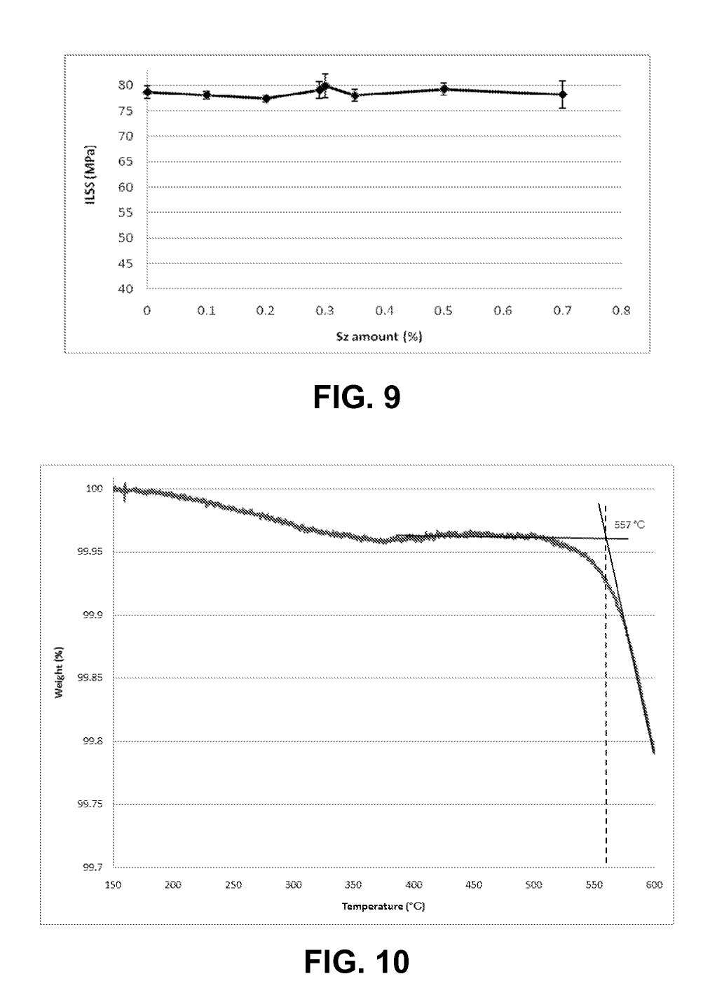

The same as the above Example 6 and Comparative Example 6, the samples were made, i.e. one with sizing amount of 0.1-0.3 wt % (Example 9) and the other with 0.3-0.7 wt % (Comparative Example 9) to conduct an ILSS test. The result is indicated in both Table 8 and FIG. 9. The error bar in the figure indicates the standard deviation. The ILSS measurements of the both samples taken from the test are almost identical. Additionally ILSS of unsized fiber were also shown.

### Example 10, Comparative Example 10

The same as the above Example 6, the carbon fiber with 0.2 wt % sizing amount were made to conduct a thermogravimetric analysis (TGA) under air atmosphere. The result is shown in FIG. 10. The heat degradation onset temperature was 557 degree Celsius, confirming a superior heat resistance demonstrated by the polyimide sizing.

### Example 11, Comparative Example 11

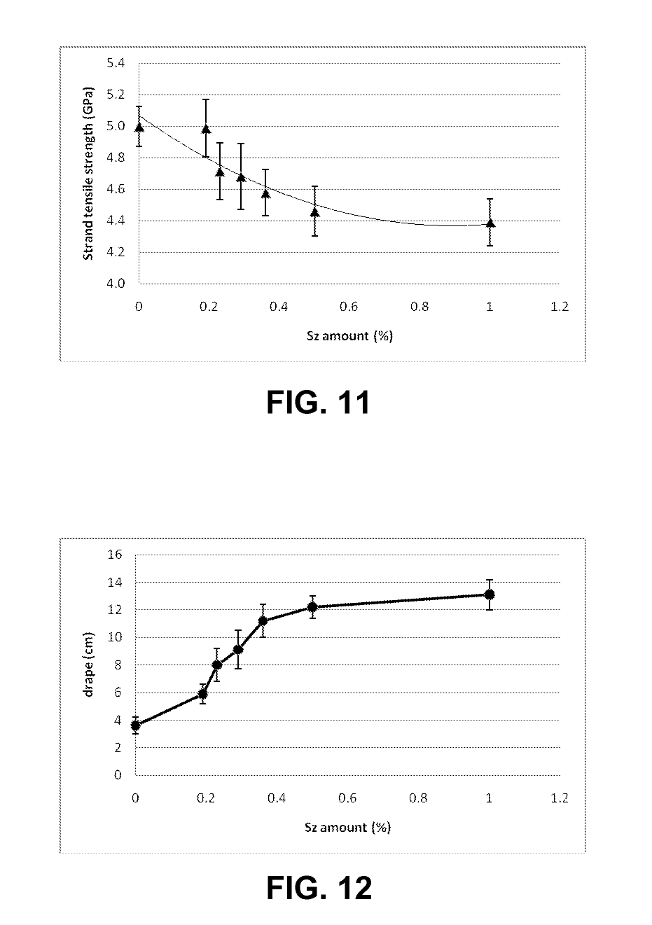

Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.1-2.0 weight % of polyamic acid (indicated in FIG. 23) ammonium salt water solution. After this process, it was dried at 290 degree Celsius for one minute in order to have polyimide coating of which composition is shown in FIG. 24. The tensile strengths of both the sizing amount of 0.1-0.3 wt % (Example 11) and 0.3-0.7 wt % (Comparative Example 11) were measured. The results are shown in both Table 9 and FIG. 11. The error bar in the figure indicates the standard deviation. The test sample of Example 11 had a higher tensile strength than the one of Comparative Example 11. Additionally mechanical properties of unsized fiber were also shown. The imidization ratio was 98%.

### Example 12, Comparative Example 12

The same as the above Example 11 and Comparative Example 11, the samples were made, i.e. one with sizing amount of 0.1-0.3 wt % (Example 12) and the other with 0.3-0.7 wt % (Comparative Example 12) to test the drape value. The result is indicated in both Table 10 and FIG. 12. The error bar in the figure indicates the standard deviation. The sample of Example 12 has superior drapeability than the one of Comparative Example 12. Additionally drape value of unsized fiber were also shown.

### Example 13, Comparative Example 13

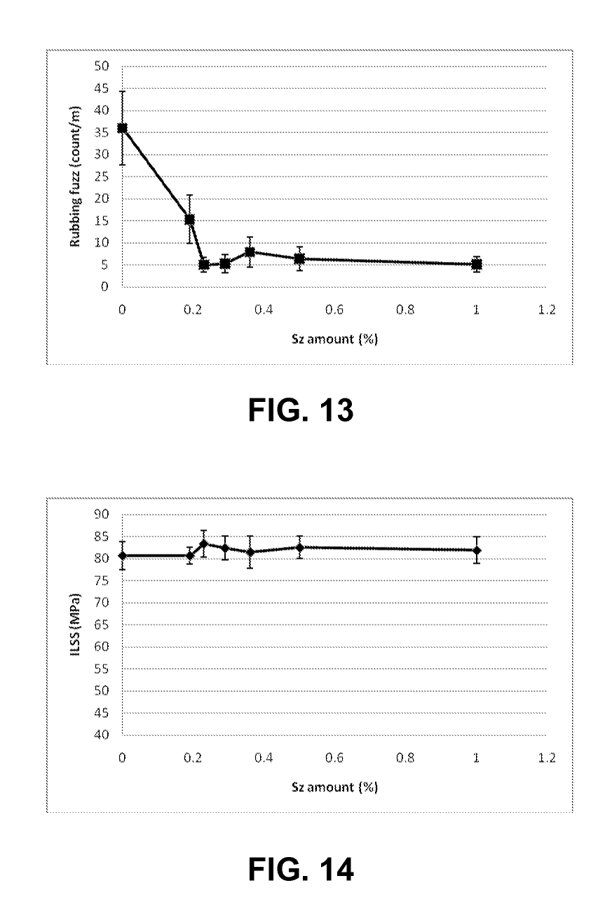

The same as the above Example 11 and Comparative Example 11, the samples were made, i.e. one with sizing amount of 0.1-0.3 wt % (Example 13), the other with 0.3-0.7 wt % (Comparative Example 13) and unsized fiber (Comparative Example 13) to conduct a fuzz count test. The result is shown in Table 11 and FIG. 13. The error bar in the figure indicates the standard deviation. The fuzz count of the both samples is almost equal. The carbon fiber without a sizing agent generated much fuzz indicating the effectiveness of sizing in preventing fuzz occurrence.

### Example 14, Comparative Example 14

The same as the above Example 11 and Comparative Example 11, the samples were made, i.e. one with sizing amount of 0.1-0.3 wt % (Example 14) and the other with 0.3-0.7 wt % (Comparative Example 14) to conduct an ILSS test. The result is indicated in both Table 12 and FIG. 14. The error bar in the figure indicates the standard deviation. The ILSS measurements of the both samples taken from the test are almost identical, verifying that the low sized (0.1-0.3 wt %) carbon fiber also has superb interfacial adhesion. Additionally ILSS of unsized fiber were also shown.

### Example 15, Comparative Example 15

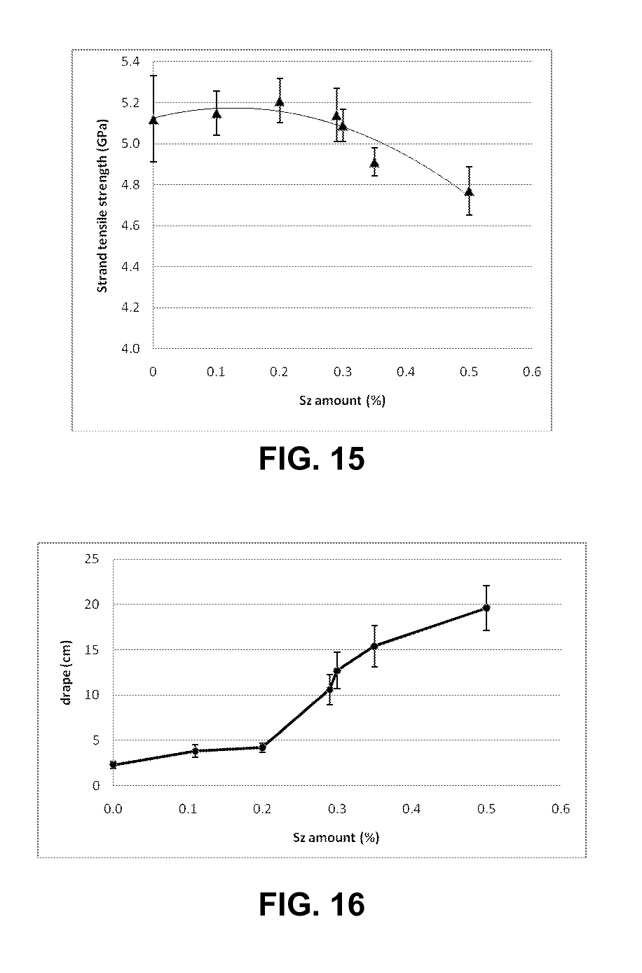

Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.1-2.0 weight % of “Torepearl” (Registered trademark by Toray Industries, Heat degradation temperature 480 degree Celsius) that is water dispersion made of PPS particulates. After this process, the carbon fiber was dried at 320 degree Celsius for one minute in order to have polyphenylenesulfide coating. The tensile strengths of both the sizing amount of 0.1-0.3 wt % (Example 15) and 0.3-0.7 wt % (Comparative Example 15) were measured. The results are shown in both Table 13 and FIG. 15. The error bar in the figure indicates the standard deviation. The test sample of Example 15 had a higher tensile strength than the one of Comparative Example 15. Additionally mechanical properties of unsized fiber were also shown.

### Example 16, Comparative Example 16

The same as the above Example 15 and Comparative Example 15, the samples were made, i.e. one with sizing amount of 0.1-0.3 wt % (Example 16) and the other with 0.3-0.7 wt % (Comparative Example 16) to test the drape value. The result is indicated in both Table 14 and FIG. 16. The error bar in the figure indicates the standard deviation. The sample of Example 16 has superior drapeability than the one of Comparative Example 16. Additionally drape value of unsized fiber were also shown.

### Example 17, Comparative Example 17

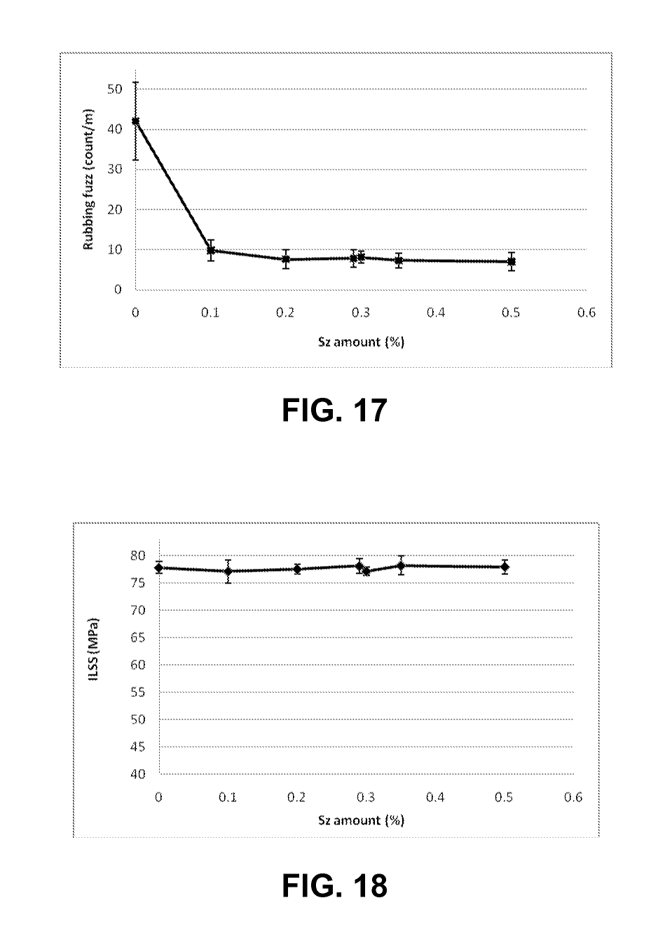

The same as the above Example 15 and Comparative Example 15, the samples were made, i.e. one with sizing amount of 0.1-0.3 wt % (Example 17) and the other with 0.3-0.7 wt % (Comparative Example 17) to conduct a fuzz count test. The result is shown in Table 15 and FIG. 17. The error bar in the figure indicates the standard deviation. The fuzz count of the both samples is almost equal. The carbon fiber without a sizing agent generated much fuzz indicating the effectiveness of sizing in preventing fuzz occurrence.

### Example 18, Comparative Example 18

The same as the above Example 15 and Comparative Example 15, the samples were made, i.e. one with sizing amount of 0.1-0.3 wt % (Example 18) and the other with 0.3-0.7 wt % (Comparative Example 18) to conduct an ILSS test. The result is indicated in both Table 16 and FIG. 18. The error bar in the figure indicates the standard deviation. The ILSS measurements of the both samples taken from the test are almost identical. Additionally ILSS of unsized fiber were also shown.

### Example 19-22, Comparative Example 19, 20

As indicated in examples 1, 6, 11, and 15, the carbon fiber with about 0.2% heat resistant sizing (examples 19-22), Torayca T800SC of 24K with about 0.6% epoxy type sizing agent, and Torayca T700SC of 12K with about 0.6% epoxy type sizing (comparative examples 19, 20) were used.

W_{f}=30% specimens were obtained by the injection molding from the 10 mm long fiber pellet of the polyetherimide matrix resin. In accordance with ASTM D 3039 and ASTM D256, we conducted the tensile test and the Izod impact test. As a result, as indicated in Table 17, the values taken from the examples were superior to the values taken from the comparative examples.

While the invention has been explained with reference to the specific embodiments of the invention, the explanation is illustrative and the invention is limited only by the appended claims.

What is claimed is:

1. A carbon fiber coated with a sizing at an amount X between 0.1 and 0.3 wt %, said sizing being formed of a heat resistant polymer or a precursor of the heat resistant polymer, said amount X being expressed with a following formula:
$$X = \frac{{w}_{0} - {w}_{1}}{{w}_{0}} \times 100$$
where W₀ is a weight of the carbon fiber with the sizing, and W₁ is a weight of the carbon fiber without the sizing.

2. The carbon fiber according to claim 1, wherein said heat resistant polymer starts being decomposed thermally at a temperature higher than 450° C.

3. The carbon fiber according to claim 1, wherein said heat resistant polymer or said precursor is applied to the carbon fiber in a form of an organic solution, an aqueous solution, an aqueous dispersion, or an aqueous emulsion.

4. The carbon fiber according to claim 1, wherein said heat resistant polymer includes at least one of a phenol resin, a melamine resin, a urea resin, a polyimide resin, a polyamideimide resin, a polyetherimide resin, a polysulfone resin, a polyethersulfone resin, a polyetheretherketone resin, a polyetherketoneketone resin, and a polyphenylenesulfide resin.

5. The carbon fiber according to claim 1 having a tensile modulus between 200 and 600 GPa.

6. The carbon fiber according to claim 1 having a tensile strength between 4.5 and 7 GPa.

7. The carbon fiber according to claim 1 having a drape value less than 15 cm.

8. The carbon fiber according to claim 1 being formed of filaments having a number between 1,000 and 48,000.

9. A composite material comprising the carbon fiber according to claim 1 and a thermoplastic resin.

10. A composite material comprising the carbon fiber according to claim 1 and a thermosetting resin.
